(19) United States
(12) Patent Application Publication
(10) Pub. No.: US 2010/0125463 A1
(43) Pub. Date: May 20, 2010

(54) Personal Information Gathering, Storing, and Transfer System

(76) Inventor: John Frank Stagl, Bradenton, FL (US)

Correspondence Address: HARSHAW RESEARCH, INC., 210 W. TECUMSEH STREET, OTTAWA, KS, 66067, US

(21) Appl. No.: 12/622,531

(22) Filed: Nov. 20, 2009

Related U.S. Application Data
(60) Provisional application No. 61/116,418, filed on Nov. 20, 2008.

(51) Int. Cl. G06Q 50/00; G06F 3/00

(52) U.S. Cl. 705/3; 710/5; 345/520

(57) ABSTRACT

A personal information gathering, storing, and transfer system having a display, an input device, and a processor in data communication with the display and input device for receiving data from the input device and actuating the display. An internal memory is in data communication with the processor and the input device for storing data received from the input device. The display and input device may be a touch screen. The system includes a USB port in data communication with the processor and internal memory. The system includes a portable memory device configured for data connection to the USB port for receiving data from the internal memory. The processor includes programming for automatically deleting data from the internal memory when transferred to the portable memory.

### CROSS REFERENCE TO RELATED APPLICATIONS

This application claims the benefit of U.S. application Ser. No. 61/116,418 filed Nov. 20, 2008 entitled PIC, an Acronym for Personal Information Capture and Store System.

### BACKGROUND OF THE INVENTION

This invention relates generally to information systems and, more particularly, to a system for gathering and storing personal medical information and then transferring it to a portable storage device for transfer and use by other selected parties.

When a patient visits a health professional, data such as full name, address, insurance, occupation, habits, social history, current health problem (if one exists), past medical history, medication, surgeries, allergies, etc. is collected. Presently, the data is generally collected using a paper form that the client/individual will fill out using a pen. This is not only time consuming but grossly redundant, whereby the client/individual is required to fill out the same or similar form for each and every medical professional visited.

Some medical establishments have added the convenience of touch screens to improve the delivery of patient data. This information may be added to the Electronic Medical Records (EMR) system at the current office only. Nevertheless, upon visiting another medical professional for the first time, the patient will again be required to fill out paperwork prior to the visit.

The main problem with this present system is that the medical establishment requires information yet often fails to share the same information with the patient who rendered it in the first place. A patient can indeed obtain copies of records from the medical professional;

however copies of records are generally unacceptable to other professionals for intake purposes. Often times the prior office logo and letterhead may be attached and the information may not be as complete as desired.

Therefore, it would be desirable to have a system by which the individual can create a portable electronic health record, establish, update and maintain control of their own medical records, and disseminate such records easily and quickly to the medical professional of their choice. Such a system would allow an individual the ability to electronically update their information privately, conveniently and inexpensively.

### SUMMARY OF THE INVENTION

The present invention is a personal information gathering, storing, and transfer system in which an individual can create a portable electronic health record, establish and maintain control of their own medical record, and have the ability to disseminate such records easily and quickly to the medical professional of their choice. The information system includes a display, an input device, and a processor in data communication with the display and input device for receiving data from the input device and actuating the display accordingly. An internal memory is in data communication with the processor and the input device for storing data received through the input device. The display and input device may be a touch screen. The system includes a USB port in data communication with the processor and internal memory. The system includes a portable memory device configured for data connection to the USB port for receiving data from the internal memory. The processor includes programming for automatically deleting data from the internal memory when transferred to the portable memory as well as other security features.

Therefore, a general object of this invention is to provide a personal information system for gathering, storing, and transferring personal medical information to a portable memory device such that the information may be provided to selected medical professionals without repeated and redundant data entry.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a personal information gathering, storing, and transfer system according to a preferred embodiment of the present invention;

FIGS. 2a to 2c are screen shots of the data acquisition module of the present invention;

FIG. 3 is a block diagram of the electronic components of the present invention; and

FIG. 4 is an isolated view on an enlarged scale of a portable electronic memory device taken from FIG. 1.

### DESCRIPTION OF THE PREFERRED EMBODIMENT

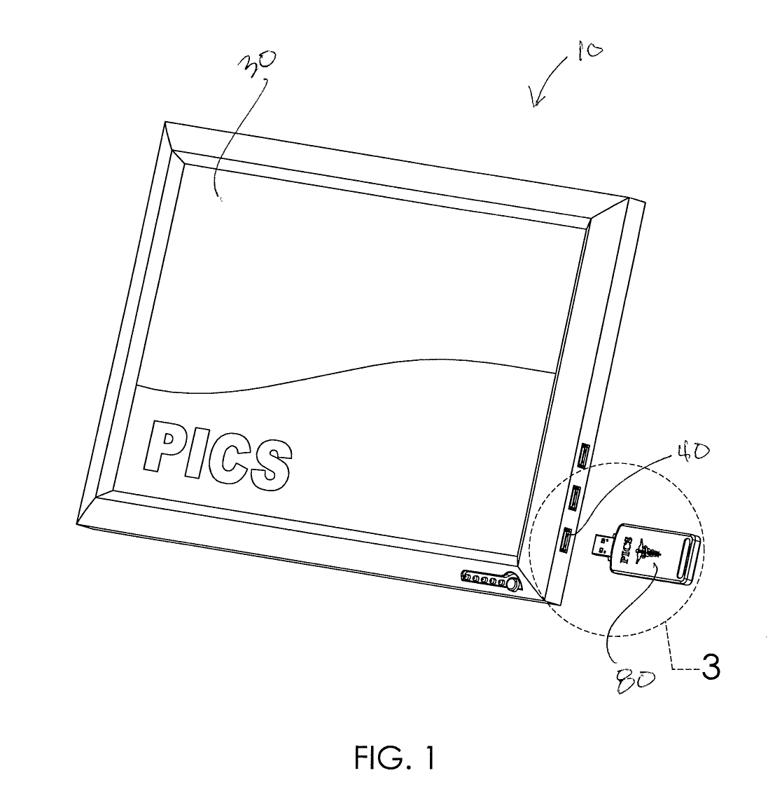

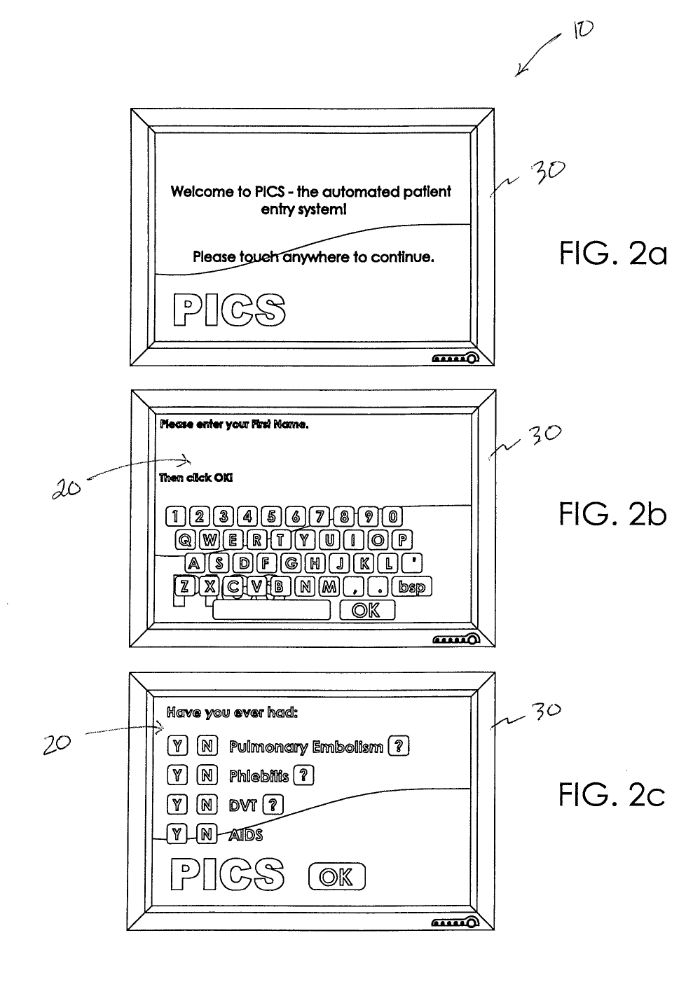

A personal information gathering, storing, and transfer system according to a preferred embodiment of the present invention will now be described with reference to FIGS. 1 to 4 of the accompanying drawings.

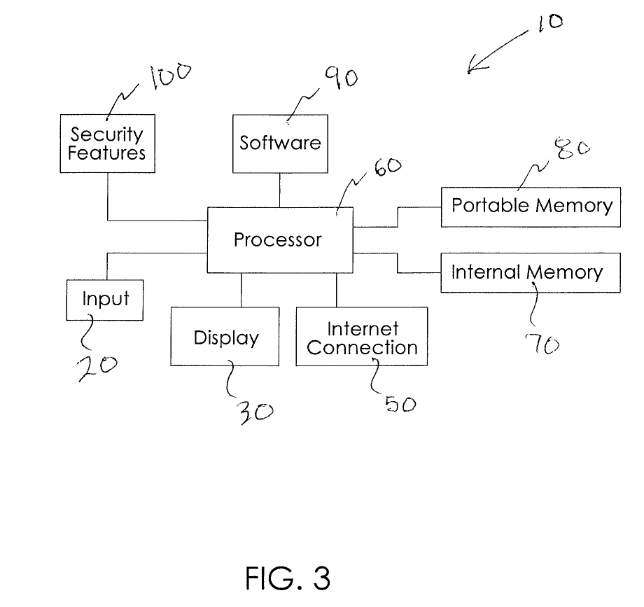

The personal information gathering, storing, and transfer system 10 (also referred to herein merely as a “personal information system”) includes an input device 20 and a display 30 (FIG. 1). Preferably, the input device 20 and the display 30 may be a touch screen. The personal information system 10 also includes a processor 60 in data communication with the input device 20 and display 30 such that data may be received from the input device 20, communicated to the processor 60, and the display 30 actuated accordingly. The electronic components of the present invention are shown in the block diagram of FIG. 3 and it is understood that the display 30 may provide a housing for many of the electronic components of the information system 10.

The information system is used exclusively to capture personal health related information such as individual full name, address, insurance information, occupation, habits, social history, their current health problem (if one exists), past medical history, medication, surgeries, allergies, etc. Although a touch screen device is preferred, any means for collecting data that can be stored electronically and made accessible by a portable memory device may be used.

The information system 10 according to the present invention further includes an internal memory 70 in connection with the input device 20 and processor 60. Data received by the input device 20 may be stored in the internal memory 70. Instructions, referred to in FIG. 3 as software 90, are stored in the internal memory 70 in data communication with the processor 60 that control entry of data through the input device 20, actuation of the display 30 accordingly, storage of data in the internal memory 70 and other operations of the processor 60 as will be described later.

Data collected through the input device 20 may be assembled under processor 60 control into a format that can be shared with others via a standard computer. More particularly, data may be assembled in a Portable Document Format (“PDF”) that may be displayed across many computer platforms, such as may be used by various medical professionals to whom it may be later submitted. A database is stored in the internal memory 70 having a plurality of program instructions, predetermined questions used in gathering personal and health information and the like. In an administrative mode, an administrator may customize which predetermined questions will be used and even to set up a help file that may later be accessed by a user when using the information system. The database may include data in various languages. Various security codes and such like may also be stored in the internal memory as will be described further later.

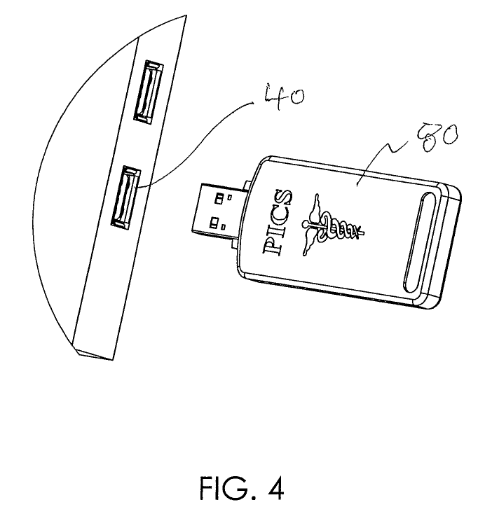

The display 30 defines a USB port 40 or other connection for auxiliary devices. It is understood, of course, that the USB port 40 may be provided on another peripheral device other than the display 30. The USB port 40 is in data communication with the processor 60 and internal memory 70 such that data stored in the internal memory 70 may be transferred to the USB port 40. The information system 10 may also include a portable memory device 80 configured to be removably connected to the USB port 40 and capable of receiving and storing data transferred from the internal memory 70 through the USB port 40. The portable memory device 80 is preferably a flash drive as shown in FIG. 4; this is preferred in that such a device may be placed on a key chain, placed in a pen, on a card similar in size to a credit card or placed on a lariat. In addition, the information system 10 may include an internet connection 50 (FIG. 3) such that data stored in the internal memory 70 may be transferred to selected remote computers, such as the user's personal computer or the computer of a selected medical professional.

The portable memory device 80 may include data storage media having data structures that are specifically configured to receive and store personal health data in a format consistent with that which is used in Electronic Medical Records (EMR). In other words, the portable memory device 80 may include specific memory locations for predetermined types of data. It is understood that the software 90 of the personal information system 10 may appropriately prepare and configure the information received through the input device 20 to be received into respective data structures of the portable memory device 80. Preferably, the software 90 and portable memory device 80 are configured to receive and store data using the Health Level 7 messaging system as this messaging system is used prominently by health professionals. Accordingly, data stored on the portable memory device 80 in a HL 7 format may be readily uploaded to the Electronic Medical Records (EMR) of other health professionals when desired by the user.

Importantly, the information system 10 includes programming for automatically deleting data from the internal memory 70 when it is transferred and stored onto the portable memory device 80. This programming is a security feature such that a user's personal data is not left on the information system 10 once it has been transferred to the portable memory device 80. This is important in that the personal information system 10 may be positioned in a public area, such as a doctor's office waiting room, a public library, a shopping mall kiosk, or other public location where it may be accessed by unrelated parties. The system may also generate an access code when data is transferred to the portable memory device 80 such that the transferred data cannot be accessed without entering the code. Alternately, other data protection methods may be used such as password protection methods. In other words, access to the portable memory device 80 may be password protected. Further, the display 30 may include a privacy screen (not shown) that prevents persons adjacent to the display 30 from viewing the screen. In FIG. 3, these security features are indicated together by reference numeral 100.

It is understood that while certain forms of this invention have been illustrated and described, it is not limited thereto except insofar as such limitations are included in the following claims and allowable functional equivalents thereof.

What is claimed is:

1. A personal information gathering, storage, and transfer system, comprising:
a display;
an input device;
a processor in data communication with said display and said input device for receiving data from said input device and for actuating said display;
an internal memory in data communication with said processor and said input device for storing data received from said input device;
a USB port in data communication with said processor and said internal memory; a portable memory device configured for connection with said USB port for receiving data from said internal memory; and
programming in data communication with said processor for deleting respective data from said internal memory when said respective data is transferred to said portable memory device.

2. The system as in claim 1, wherein said input device and said display is a touch screen.

3. The system as in claim 1, wherein said portable storage device is a flash drive.

4. The system as in claim 1, further comprising a privacy screen attached to a front side of said display, whereby said first display is not visible to persons adjacent said first display.

5. The system as in claim 1, further comprising:
an electrical connection to the internet; and
programming in data communication with said processor for selectively transferring data through said internet connection to a remote computer.

6. The system as in claim 5, wherein said input device and said display is a touch screen.

7. The system as in claim 1, wherein said data received through said input device includes data selected from the group including personal name and address, insurance, occupation, social history, current health issues, past medical history, medications, past surgeries, and allergies.

8. The system as in claim 7, wherein said data received through said input device is saved in the Portable Document Format (pdf) so as to be selectively transferred and displayed on remote computers.

9. The system as in claim 1, wherein data transferred to said portable memory device is password protected.

10. The system as in claim 2, wherein said internal memory includes a digital help file that is accessible by user operation of said touch screen.

11. The system as in claim 1, further comprising programming for displaying data on said display in selected languages.

12. The system as in claim 1, wherein said internal memory includes a database of medical history questions for display upon said display;
said system further comprising programming enabling an administrator to select respective questions from said database to be displayed on said display.

13. The system as in claim 1, wherein said portable memory device includes data structures for receiving said data from said internal memory device in an Electronic Medical Record (“EMR”) format, wherein said data received into said portable memory device is configured to be compatible with an EMR of a remote health professional computer.

14. The system as in claim 13, wherein said software includes programming for arranging said data received from said input device in an Electronic Medical Record “EMR” format.

15. The system as in claim 13, wherein said Electronic Medical Record format is a Health Level 7 format.

16. The system as in claim 15, wherein said data structures of said portable memory device are compatible with said Health Level 7 format.
